(19) United States
(12) Patent Application Publication
(10) Pub. No.: US 2026/0153694 A1
(43) Pub. Date: Jun. 4, 2026

(54) MPO FIBER OPTIC CONNECTOR

(71) Applicant: Zhejiang Oryarwa Communication Equipment Co., Ltd., Yueqing City (CN)

(72) Inventors: Xiaokuang WANG, Yueqing City (CN); Xiahua Yun, Yueqing City (CN); Rongqian Lin, Yueqing City (CN)

(21) Appl. No.: 19/237,096

(22) Filed: Jun. 13, 2025

(30) Foreign Application Priority Data
Dec. 4, 2024 (CN) 202422973874.7
Mar. 6, 2025 (CN) 202520380699.2

(51) Int. Cl. G02B 6/38

(52) U.S. Cl. CPC G02B 6/3887; G02B 6/3893

(57) ABSTRACT

An MPO fiber optic connector is disclosed in the present application, the MPO fiber optic connector includes a bushing, a housing and a ferrule assembly, a rear end of the bushing is provided with a stopper, a first spring is provided between the ferrule assembly and the stopper, and a second spring is provided between the bushing and the housing; the rear end of the housing is connected to a tail boot, the tail boot is connected to the housing through a connection member at a front end of the tail boot, the connection member includes a flange, a connection portion, and a convex platform; a rear end of the housing is sleeved on the convex platform, a first gap is defined between the groove and the buckle, a second gap is defined between the housing and the flange.

### FIELD

The present application relates to the field of optical fiber communication technology, in particular to an MPO fiber optic connector.

### BACKGROUND

Multi push on (MPO) fiber optic connector is a high-density, multi-core fiber optic connector designed to simplify the connection and management of multi-core fiber optic networks. The structure of a traditional MPO fiber optic connector includes: a bushing, a housing slidably disposed outside the bushing and a ferrule assembly movably disposed inside the bushing, a stopper is provided at the rear end of the bushing, a first spring is provided between the ferrule assembly and the stopper, and a second spring is provided between the housing and the bushing. When the MPO fiber optic connector needs to be unplugged from an adapter, the operator can usually plug and unplug the connector from the adapter by holding the housing of the MPO fiber optic connector. However, as the size of the MPO fiber optic connector is gradually reduced, fiber optic cabling cabinet and optical module are becoming denser and smaller, it becomes very difficult for operator to complete the unlocking the MPO fiber optic connector from the adapter by holding the housing of the MPO fiber optic connector. In response to the above problem, Chinese Invention Patent No. ‘CN110609357A’, entitled ‘An MPO fiber optic connector unlocked by using a tail boot’, discloses connecting a movable tail boot at the rear end of the housing, the operator can unlock the MPO fiber optic connector and the adapter by holding the tail boot, thus facilitating operation. However, the processes of plugging and unplugging the MPO may be unstable, and prone to jam.

Therefore, improvement is desired.

### SUMMARY OF THE DISCLOSURE

The purpose of the present application is to provide an MPO fiber optic connector that is easy to plug and unplug.

The MPO fiber optic connector provided by the present application includes a bushing, a housing slidably disposed outside the bushing and a ferrule assembly movably disposed inside the bushing, wherein: a rear end of the bushing is provided with a stopper, a first spring is provided between the ferrule assembly and the stopper, and a second spring is provided between the bushing and the housing; the rear end of the housing is connected to a tail boot, the tail boot is connected to the housing through a connection member at a front end of the tail boot, the connection member comprises a flange, a connection portion integrally formed at a rear end of the flange, and a convex platform integrally formed at a front end of the flange, a front end of the convex platform is provided with a positioning groove adapted to a rear end of the stopper, the convex platform is provided with two buckles on respective sides of the convex platform, the housing is provided with two grooves on respective sides of the housing, and the two grooves are respectively connected to the two buckles; a rear end of the housing is sleeved on the convex platform, a first gap is defined between the groove and the buckle, a second gap is defined between the housing and the flange, and the tail boot is connected to the connection portion.

Optionally, the rear end of the stopper is provided with a protrusion portion, and the protrusion portion is embedded in the positioning groove.

Optionally, two sides of the bushing are respectively provided with a first positioning block, a first positioning groove is defined between the two buckles, and the first positioning groove is positioned and matched with the first positioning block.

Optionally, two sides of the bushing are respectively provided with a first positioning hanging platform, two inner sides of the housing are respectively provided with a second positioning hanging platform, and the first positioning hanging platform is positioned and match with the second positioning hanging platform.

Optionally, a front end of at least one first positioning hanging platform extends with a guide rail, and a guide groove is defined inside the housing to guide and cooperate with the guide rail.

Optionally, a rear end of the bushing is provided with a second positioning block, the housing is provided with a second positioning groove, and the second positioning groove is positioned and matched with the second positioning block.

Optionally, the connection portion is provided with a filling groove, and the tail boot is integrally formed on the connection portion by insert injection molding.

Optionally, a rear end of the tail boot is integrally formed with a handle.

The advantages of the MPO fiber optic connector of the present application are as follows: (1). the tail boot is connected to the housing through the double buckles on respective sides of the connection member, and a plurality of positioning structures can be disposed on the connection member and the housing, which makes it more stable and less likely to be jammed when it is pushed or pulled; (2). plugging and unplugging can be carried out individually by means of the housing as well and it does not add to the resistance to plugging and unplugging.

### BRIEF DESCRIPTION OF THE DRAWINGS

Implementations of the present application will now be described, by way of embodiment, with reference to the attached figures.

FIG. 1 is a schematic diagram of an embodiment of an MPO fiber optic connector of the present application.

FIG. 2 is an exploded view of the MPO fiber optic connector of FIG. 1.

FIG. 3 is a cross-sectional view of the MPO fiber optic connector taken along the line A-A of FIG. 1.

FIG. 4 is a schematic diagram of an embodiment of a connection member of the present application.

FIG. 5 is a schematic diagram of a bushing of the present application, viewed at an angle.

FIG. 6 is a schematic diagram of the bushing of the present application, viewed at another angle.

FIG. 7 is a cross-sectional view of an embodiment of a housing of the present application.

### DETAILED DESCRIPTION

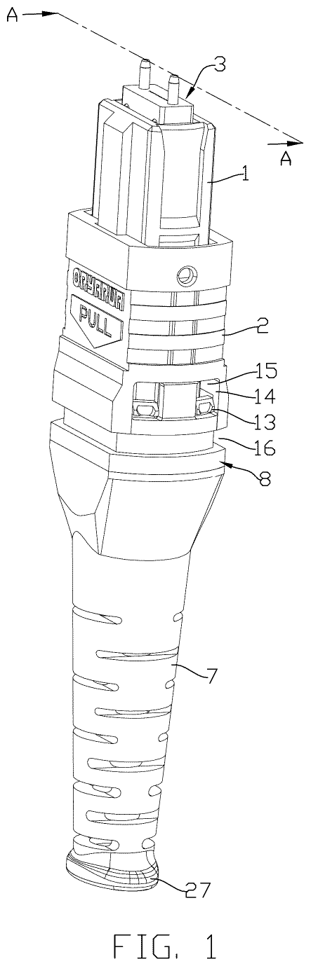

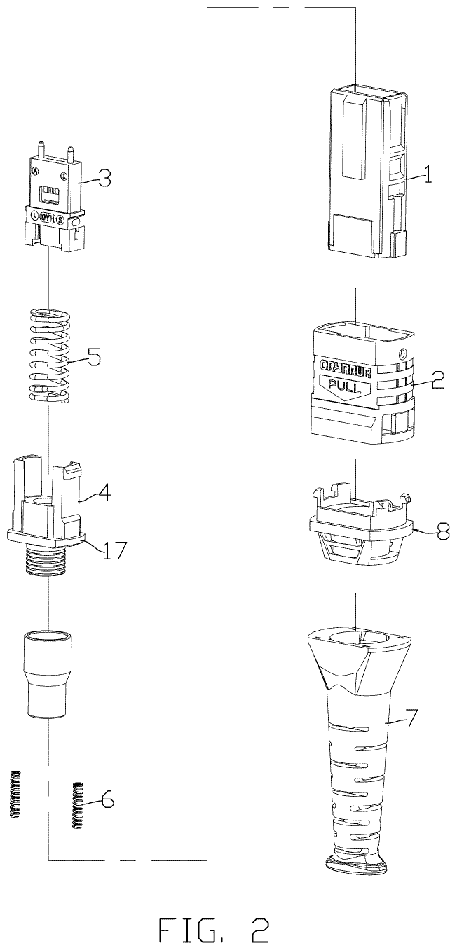

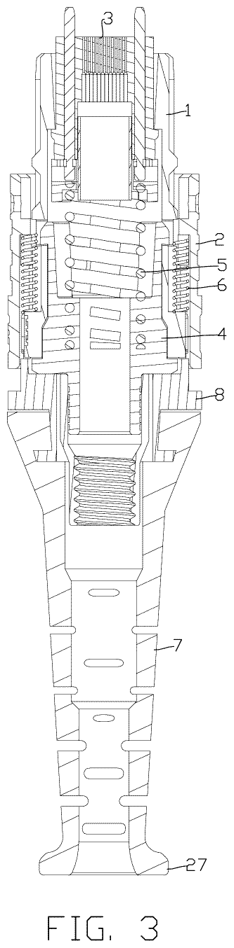

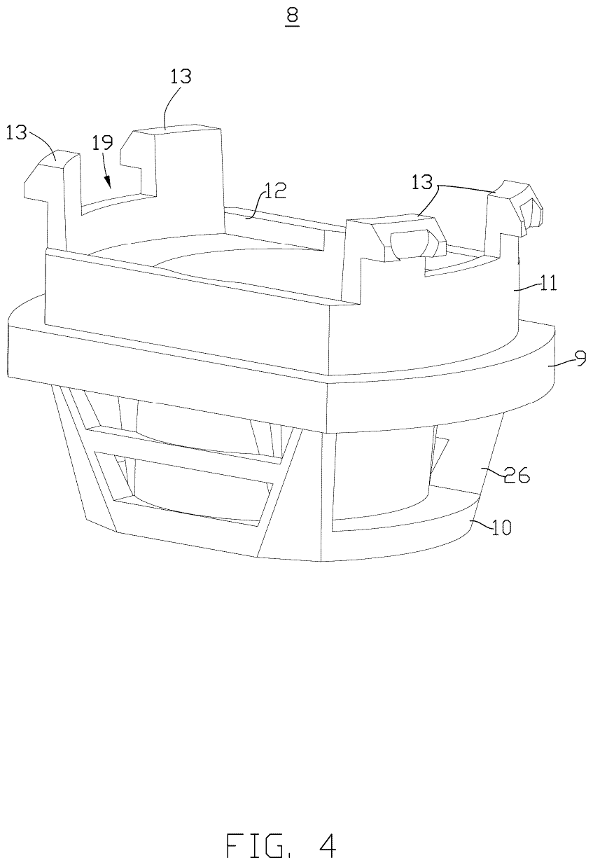

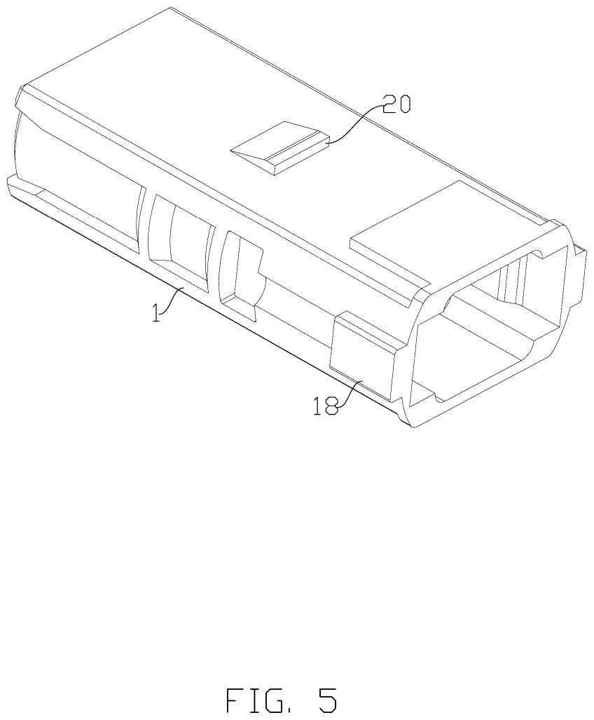

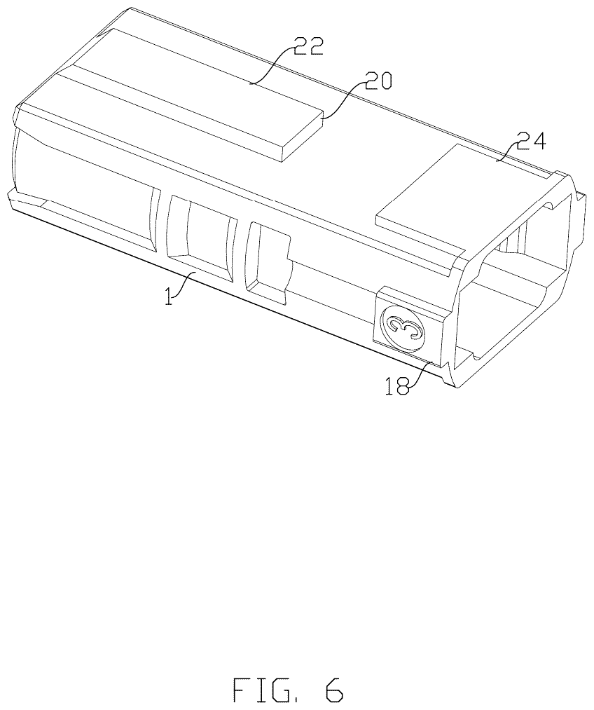

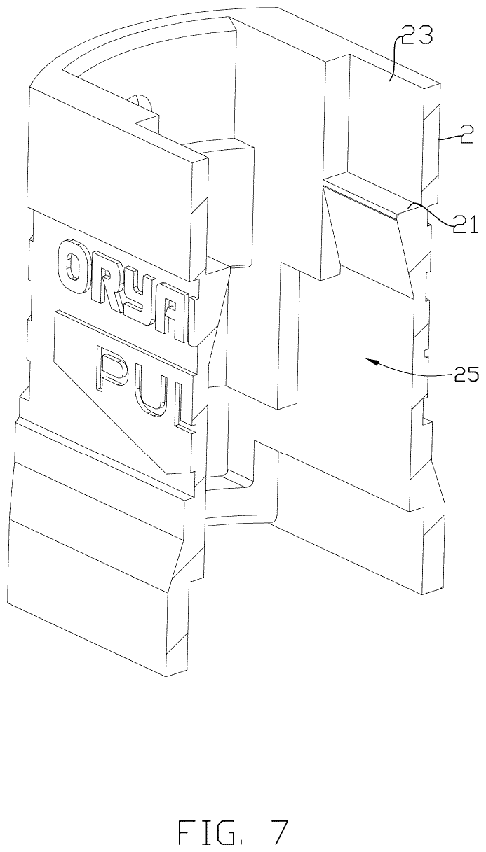

Referring to FIGS. 1 to 7, an MPO fiber optic connector provided by the present application includes a bushing 1, a housing 2 slidably disposed outside the bushing 1 and a ferrule assembly 3 movably disposed inside the bushing 1. The rear end of the bushing 1 is provided with a stopper 4, a first spring 5 is held between the ferrule assembly 3 and the stopper 4, which ensures that the ferrule assembly 3 can move inside the bushing 1, a second spring 6 is provided between the bushing 1 and the housing 2, and the housing 2 is reset by the second spring 6 after sliding down. The rear end of the housing 2 is provided with a tail boot 7, and the tail boot 7 is connected to the housing 2 through the connection member 8 at the front end. The connection member 8 includes a flange 9, a connection portion 10 integrally formed at the rear end of the flange 9, and a convex platform 11 integrally formed at the front end of the flange 9. The tail boot 7 is connected to the connection portion 10. The front end of the convex platform 11 is provided with a positioning groove 12, the positioning groove 12 is adapted to the rear end of the stopper 4, and the rear end of the stopper 4 is positioned in the positioning groove 12, thereby improving the stability of the connection between the connection member 8 and the bushing 1. The convex platform 11 is provided with two spaced buckles 13 on respective sides of the convex platform 11, in other words, one side of the convex platform 11 is provided with two spaced buckles 13, and another side of the convex platform 11 is also provided with two spaced buckles 13. The housing 2 is provided with two spaced grooves 14 on respective sides of the housing 2. In other words, one side of the housing 2 is provided with two spaced grooves 14, and the two spaced grooves 14 are respectively corresponded to the two spaced buckles 13 of the one side of the convex platform 11, another side of the housing 2 is also provided with two spaced grooves 14, and the two spaced grooves 14 are respectively corresponded to the two spaced buckles 13 of another side of the convex platform 11. A buckle 13 can be connected to a corresponding groove 14, thereby improving the stability of the connection between the housing 2 and the convex platform 11. The rear end of the housing 2 is sleeved on the convex platform 11 to further improve the stability of the connection between the housing 2 and the convex platform 11. A first gap 15 is defined between the groove 14 and the buckle 13, and a second gap 16 is defined between the housing 2 and the flange 9. By setting the first gap 15 and the second gap 16, in addition to plugging and unplugging the housing 2 through the tail boot 7, the present application allows plugging and unplugging the housing 2 by holding the housing 2 in the hand and without driving the tail boot 7 during the plugging and unplugging process, and therefore without increasing the plugging and unplugging resistance.

Optionally, the rear end of the stopper 4 is provided with a protrusion portion 17 that can be embedded in the positioning groove 12 to further improve the stability of the connection between the connection member 8 and the stopper 4.

Optionally, two sides of the bushing 1 are respectively provided with a first positioning block 18, and a first positioning groove 19 is defined between the two spaced buckles 13, and the first positioning groove 19 is positioned and matched with the first positioning block 18. One end of the second spring 6 is positioned at the top of the first positioning block 18 to further improve the stability of the connection between the connection member 8 and the bushing 1.

Optionally, two sides of the bushing 1 are respectively provided with a first positioning hanging platform 20, and two inner sides of the housing 2 are respectively provided with a second positioning hanging platform 21, two first positioning hanging platforms 20 are respectively corresponded to two second positioning hanging platforms 21, and a first positioning hanging platform 20 is positioned and match with a corresponding second positioning hanging platform 21. When assembled, the housing 2 is forcibly inserted from the front end of the bushing 1, and the second positioning hanging platform 21 is clamped into the rear end of the first positioning hanging platform 20 to achieve positioning of the housing 2.

Optionally, a guide rail 22 extends from the front end of the at least one first positioning hanging platform 20, and a guide groove 23 is provided inside the housing 2 to guide and cooperate with the guide rail 22, so that the housing 2 can be more accurately sleeved on the bushing 1, and the sliding of the housing 2 is also more stable.

Optionally, the rear end of the bushing 1 is provided with a second positioning block 24, and the housing 2 is provided with a second positioning groove 25, and the second positioning groove 25 is positioned and matched with the second positioning block 24 to further improve the stability of the connection between the bushing 1 and the housing 2.

Optionally, the connection portion 10 is provided with a filling groove 26, and the tail boot 7 is integrally formed on the connection portion 10 by insert injection molding, to increase the strength of the connection between the tail boot 7 and the connection portion 10. The tail boot 7 can be made of soft rubber, the connection member 8 may be made of hard plastic, and the insert injection molding is a conventional connection process.

Optionally, the rear end of the tail boot 7 is integrally formed with a handle 27 to facilitate user grasping and prevent slipping.

Even though numerous characteristics and advantages of the present technology have been set forth in the foregoing description, together with details of the structure and function of the present application, the application is illustrative only, and changes may be made in the detail, especially in matters of shape, size, and arrangement of the parts within the principles of the present application, up to and including the full extent established by the broad general meaning of the terms used in the claims. It will, therefore, be appreciated that the exemplary embodiments described above may be modified within the scope of the claims.

What is claimed is:

1. A multi push on (MPO) fiber optic connector comprising a bushing, a housing slidably disposed outside the bushing and a ferrule assembly movably disposed inside the bushing, wherein:
a rear end of the bushing is provided with a stopper, a first spring is provided between the ferrule assembly and the stopper, and a second spring is provided between the bushing and the housing; the rear end of the housing is connected to a tail boot,
the tail boot is connected to the housing through a connection member at a front end of the tail boot, the connection member comprises a flange, a connection portion integrally formed at a rear end of the flange, and a convex platform integrally formed at a front end of the flange, a front end of the convex platform is provided with a positioning groove adapted to a rear end of the stopper, the convex platform is provided with two buckles on respective sides of the convex platform, the housing is provided with two grooves on respective sides of the housing, and the two grooves are respectively connected to the two buckles;
a rear end of the housing is sleeved on the convex platform, a first gap is defined between the groove and the buckle, a second gap is defined between the housing and the flange, and the tail boot is connected to the connection portion.

2. The MPO fiber optic connector according to claim 1, wherein the rear end of the stopper is provided with a protrusion portion, and the protrusion portion is embedded in the positioning groove.

3. The MPO fiber optic connector according to claim 1, wherein two sides of the bushing are respectively provided with a first positioning block, a first positioning groove is defined between the two buckles, and the first positioning groove is positioned and matched with the first positioning block.

4. The MPO fiber optic connector according to claim 1, wherein two sides of the bushing are respectively provided with a first positioning hanging platform, two inner sides of the housing are respectively provided with a second positioning hanging platform, and the first positioning hanging platform is positioned and match with the second positioning hanging platform.

5. The MPO fiber optic connector according to claim 4, wherein a front end of at least one first positioning hanging platform extends with a guide rail, and a guide groove is defined inside the housing to guide and cooperate with the guide rail.

6. The MPO fiber optic connector according to claim 4, wherein a rear end of the bushing is provided with a second positioning block, the housing is provided with a second positioning groove, and the second positioning groove is positioned and matched with the second positioning block.

7. The MPO fiber optic connector according to claim 1, wherein the connection portion is provided with a filling groove, and the tail boot is integrally formed on the connection portion by insert injection molding.

8. The MPO fiber optic connector according to claim 1, wherein a rear end of the tail boot is integrally formed with a handle.

9. A multi push on (MPO) fiber optic connector comprising a bushing, a housing slidably disposed outside the bushing and a ferrule assembly movably disposed inside the bushing, wherein:
a rear end of the bushing is provided with a stopper, a first spring is provided between the ferrule assembly and the stopper, and a second spring is provided between the bushing and the housing; the rear end of the housing is connected to a tail boot,
the tail boot is connected to the housing through a connection member at a front end of the tail boot, the connection member comprises a flange, a connection portion integrally formed at a rear end of the flange, and a convex platform integrally formed at a front end of the flange, a front end of the convex platform is provided with a positioning groove adapted to a rear end of the stopper, the convex platform is provided with two buckles on respective sides of the convex platform, the housing is provided with two grooves on respective sides of the housing, and the two grooves are respectively connected to the two buckles; and
a rear end of the housing is sleeved on the convex platform, a first gap is defined between the groove and the buckle, a second gap is defined between the housing and the flange, and the tail boot is connected to the connection portion;
wherein a rear end of the tail boot is integrally formed with a handle.

10. The MPO fiber optic connector according to claim 9, wherein the rear end of the stopper is provided with a protrusion portion, and the protrusion portion is embedded in the positioning groove.

11. The MPO fiber optic connector according to claim 9, wherein two sides of the bushing are respectively provided with a first positioning block, a first positioning groove is defined between the two buckles, and the first positioning groove is positioned and matched with the first positioning block.

12. The MPO fiber optic connector according to claim 9, wherein two sides of the bushing are respectively provided with a first positioning hanging platform, two inner sides of the housing are respectively provided with a second positioning hanging platform, and the first positioning hanging platform is positioned and match with the second positioning hanging platform.

13. The MPO fiber optic connector according to claim 12, wherein a front end of at least one first positioning hanging platform extends with a guide rail, and a guide groove is defined inside the housing to guide and cooperate with the guide rail.

14. The MPO fiber optic connector according to claim 12, wherein a rear end of the bushing is provided with a second positioning block, the housing is provided with a second positioning groove, and the second positioning groove is positioned and matched with the second positioning block.

15. The MPO fiber optic connector according to claim 9, wherein the connection portion is provided with a filling groove, and the tail boot is integrally formed on the connection portion by insert injection molding.
